(19) United States
(12) Patent Application Publication
(10) Pub. No.: US 2024/0426741 A1
(43) Pub. Date: Dec. 26, 2024

(54) CORROSION TREATMENT SYSTEMS

(71) Applicants: Saudi Arabian Oil Company, Dhahran (SA); King Fahd University of Petroleum & Minerals, Dhahran (SA)

(72) Inventors: Turki Abdullah Al-Khaldi, Daharan (SA); Ahmad A. Sorour, Dhahran (SA); Sadam Al-Azani, Dhahran (SA); Ime Bassey Obot, Dhahran (SA); Anas S. Rushaid, Khobar (SA)

(21) Appl. No.: 18/338,048

(22) Filed: Jun. 20, 2023

(51) Int. Cl. G01N 17/00; G06N 20/00

(52) U.S. Cl. CPC G01N 17/00; G06N 20/00

(57) ABSTRACT

Disclosed are methods, systems, and computer-readable medium to perform operations including: receiving real-time data associated with a component of a hydrocarbon production system; generating, using a first machine learning model and based on the real-time data, a corrosion rate for the component; determining that the corrosion rate is greater than a predetermined threshold; responsively using a second machine learning model to calculate for the component one or more mitigated corrosion rates when using one or more available corrosion inhibitors; selecting, based on the one or more mitigated corrosion rates, one of the available corrosion inhibitors to use to mitigate the corrosion rate of the component; and responsively performing one or more mitigating actions to mitigate the corrosion rate of the component.

### TECHNICAL FIELD

This description relates to corrosion treatment systems.

### BACKGROUND

Infrastructure corrosion is a significant problem in the oil and gas industry. Structures, components (e.g., carbon steel components), and equipment (e.g., storage tanks and pipes) are subject to corrosion over time due factors, such as the accumulation of moisture and exposure to hydrocarbon flows. One way that the industry addresses this problem is by using corrosion inhibitors. Corrosion inhibitors are chemicals that prevent, reduce, or inhibit the corrosion of metals. One way that the industry applies a corrosion inhibitor is by injecting the corrosion inhibitor into the hydrocarbon retrieval or production process, e.g., by injecting the corrosion inhibitor into the hydrocarbon flow whether gas or liquid itself.

### SUMMARY

Different types of corrosion inhibitors have different properties that are useful in different scenarios. As a result of having different properties, the different corrosion inhibitors differ in their effectiveness under given conditions. One measure of corrosion inhibitor effectiveness is the efficiency of a corrosion inhibitor. Simply, the efficiency of a corrosion inhibitor provides an indication of how well the corrosion inhibitor treats a particular corrosion under certain conditions.

Some of the factors for selecting a corrosion inhibitor include the inhibition performance of the corrosion inhibitor under the given conditions, availability of the corrosion inhibitor, and cost of the corrosion inhibitor. However, the cost of evaluating a corrosion and screening corrosion inhibitors is resource intensive (e.g., requires significant time, cost, personnel, and equipment). For example, in existing solutions, techniques for estimating corrosion damage and selecting a corrosion inhibitor require physical measurements and extensive tests at different locations.

This disclosure describes systems and methods for corrosion risk assessment, corrosion prediction in hydrocarbon applications, and corrosion inhibitor selection. The disclosed systems and methods can predict the corrosion risk level, and if the corrosion level requires treatment, use a machine learning model to select a corrosion inhibitor to treat the corrosion. More specifically, the systems and methods predict the corrosion rate or provide a corrosion risk assessment and select one or more effective corrosion inhibitors to mitigate or inhibit the corrosion.

One aspect of the subject matter described in this specification may be embodied in a method implemented using a system for managing operations involving receiving real-time data associated with a component of a hydrocarbon production system; generating, using a first machine learning model and based on the real-time data, a corrosion rate for the component; determining that the corrosion rate is greater than a predetermined threshold; responsively using a second machine learning model to calculate for the component one or more mitigated corrosion rates when using one or more available corrosion inhibitors; selecting, based on the one or more mitigated corrosion rates, one of the available corrosion inhibitors to use to mitigate the corrosion rate of the component; and responsively performing one or more mitigating actions to mitigate the corrosion rate of the component.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the first and second machine learning models are trained using at least one of: historical field data, simulation data, or lab data.

In some implementations, the first and second machine learning models are trained using at least one of gradient boosting classifiers or random forest classifiers.

In some implementations, the at least one of the gradient boosting classifiers or the random forest classifiers are evaluated using at least one of coefficient of determination, root mean squared error (RMSE), mean absolute error (MAE), or mean absolute percentage error (MAPE).

In some implementations, the real-time data includes at least one of: a chlorides concentration in parts per million (ppm), pH, hydrogen sulfide (H₂S) mole percent (mole %), carbon dioxide (CO₂) mole %, O₂ mole %, temperature (° F.), pressure in pounds per square gauge (psig), test duration in hours (h), or flow speed in revolutions per minute (RPM).

In some implementations, responsively performing one or more mitigating actions to mitigate the corrosion rate of the component involves at least one of displaying on a display device an indication of the selected corrosion inhibitor, sounding an audible alarm indicating that the corrosion rate is greater than the predetermined threshold, or causing the selected corrosion inhibitor to be injected into an appropriate hydrocarbon stream that comes into contact with the component.

In some implementations, selecting, based on the one or more mitigated corrosion rates, one of the available corrosion inhibitors to use to mitigate the corrosion rate of the component further involves selecting a concentration of the selected available corrosion inhibitor.

In some implementations, the selected available corrosion inhibitor has the lowest one of the one or more mitigated corrosion rates.

The details of one or more embodiments of these systems and methods are set forth in the accompanying drawings and description below. Other features, objects, and advantages of these systems and methods will be apparent from the description, drawings, and claims.

### BRIEF DESCRIPTION OF THE DRAWINGS

FIG. 1 illustrates an example corrosion treatment system, according to some implementations.

FIG. 2 illustrates an example method, according to some implementations.

FIG. 3 is a block diagram of an example computer system, according to some implementations.

Like reference numbers and designations in the various drawings indicate like elements.

### DETAILED DESCRIPTION

The following detailed description describes systems and methods for corrosion inhibitor selection. Various modifications, alterations, and permutations of the disclosed implementations can be made and will be readily apparent to those skilled in the art, and the general principles defined may be applied to other implementations and applications without departing from the scope of the disclosure. Thus, the present disclosure is not intended to be limited to the described or illustrated implementations, but is to be accorded the widest scope consistent with the principles and features disclosed.

This disclosure describes systems and methods for corrosion risk assessment, corrosion prediction in hydrocarbon applications, and corrosion inhibitor selection. The systems and methods can predict a corrosion risk level for a particular component in a hydrocarbon retrieval or production system, and if the corrosion level requires treatment, use a machine learning model to select a corrosion inhibitor to treat the corrosion. More specifically, the disclosed systems and methods predict the corrosion rate or provide a corrosion risk assessment and select one or more effective corrosion inhibitors for treating the corrosion.

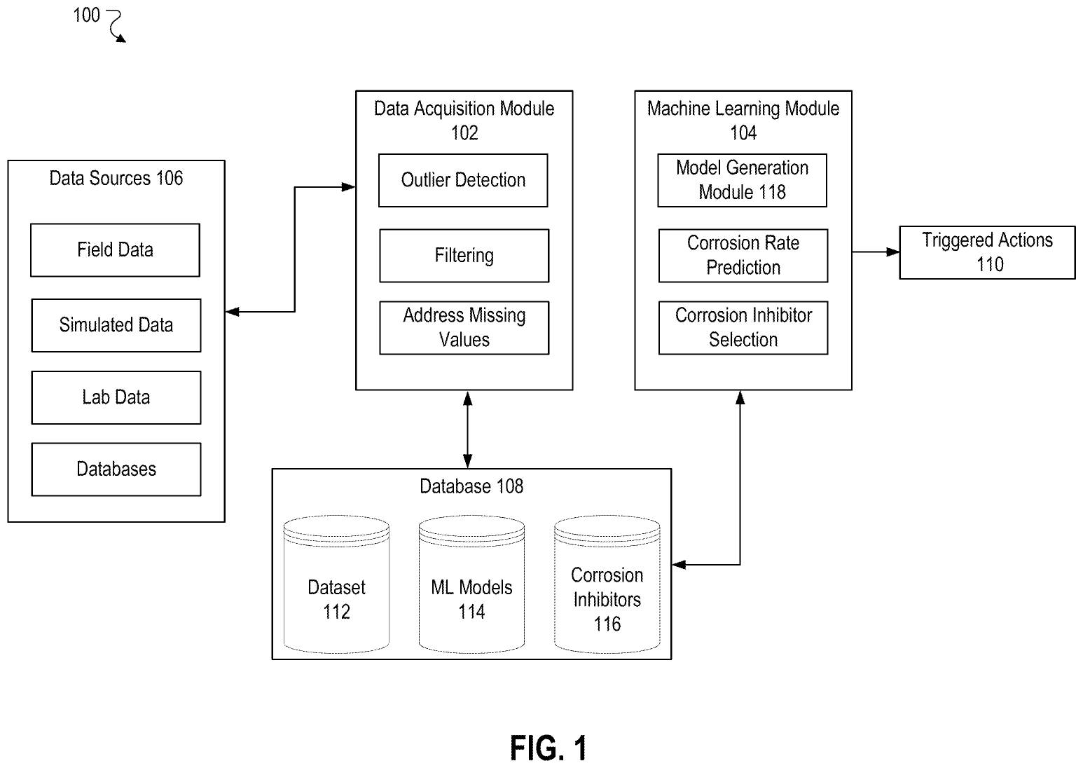

FIG. 1 illustrates an example corrosion treatment system 100, according to some implementations. The corrosion treatment system 100 can be used for corrosion risk assessment, corrosion prediction in oil and gas applications, and/or corrosion inhibitor selection. As shown in FIG. 1, the corrosion treatment system 100 includes data acquisition module 102 and machine learning module 104. In some examples, the corrosion treatment system 100 performs the corrosion risk assessment for one or more components, equipment, or structures in a hydrocarbon production system. The corrosion risk assessment can be configured to perform the corrosion risk assessment periodically and/or in response to user input. As described in more detail below, the corrosion treatment system 100 can perform one or more triggered actions 110 based on the corrosion risk assessment, corrosion prediction in oil and gas applications, and/or corrosion inhibitor selection.

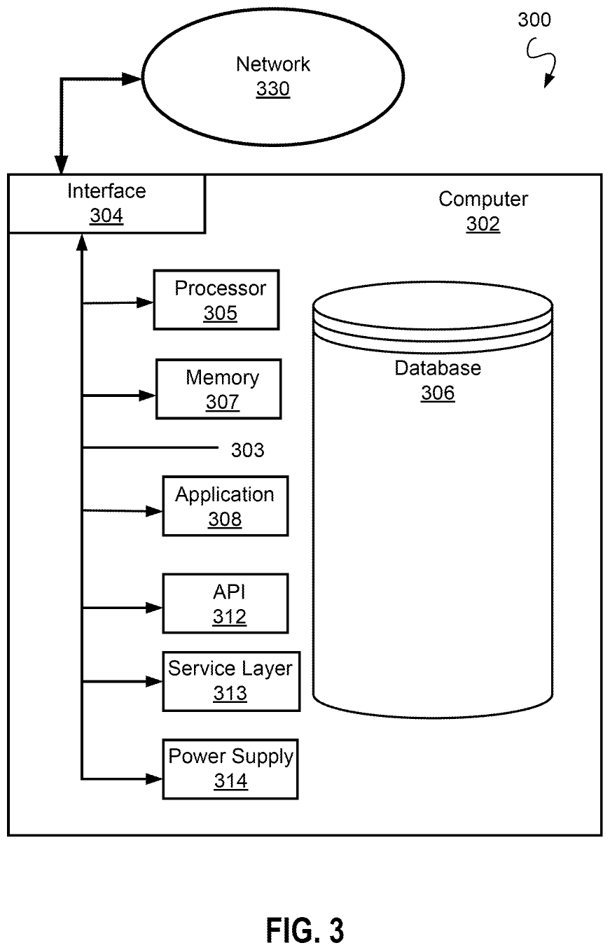

The computing device representing the corrosion treatment system 100 can be a special-purpose hardware integrated circuit of the computer system, e.g., one that includes one or more processor microchips. The computing device can also be included in a computer system 300, which is described later with reference to FIG. 3. The special-purpose circuitry can be used to implement machine-learning algorithms corresponding to learning or inference techniques that are implemented using, for example, neural networks or support vector machines. In general, the computing device can include processors, for example, a central processing unit (CPU) and a graphics-processing unit (GPU), memory, and data storage devices that collectively form one or more computing devices of computer systems.

In some implementations, the data acquisition module 102 obtains input data from one or more data sources 106. The input data can include real data (e.g., real-time field data, historical field data, or both), experimental lab data, simulated data (e.g., generated using simulation software), and/or data that is stored in local or online databases. The input data can include data related to the use of corrosion inhibitors, such as the effectiveness of different corrosion inhibitors on different materials under various conditions and/or the inhibition performance of different corrosion inhibitors on different materials under various conditions. The input data can also include data related to the acquisition of corrosion inhibitors, such as the commercial suppliers of the corrosion inhibitors, historical and/or current cost of the corrosion inhibitors, and/or historical and/or current availability of the corrosion inhibitors.

In some implementations, the data acquisition module 102 processes the input data by performing one or more processing and/or refinement operations on the input data. Within examples, the one or more operations include outlier detection, input parameter selection, addressing missing values, normalization, filtering, and/or data reduction. The data acquisition module 102 saves the input data and/or the processed input data in a database 108. For example, the data acquisition module 102 can save the input data and/or the processed input data as dataset 112 in the database 108

In some implementations, the data acquisition module 102 applies data processing techniques on at least a portion of the input data obtained by the data acquisition module 102, for example, to identify abnormal production data behavior in response to processing the received input data. The data acquisition module 102 is configured to perform quality assurance/quality control (QA/QC) processes on the input data. For example, the data acquisition module 102 can include a data model that is trained to apply one or more QA/QC techniques. The QA/QC data model is configured to perform one or more functions that preserve or enhance data integrity of the input data. The QA/QC model is operable to detect and delete “missing” data points in the input data. For example, the QA/QC model can identify and discard production datasets with “NA” or blanks for a given data field or parameter of the dataset. The QA/QC model is operable to ensure computations of average values use relevant data. The QA/QC model is operable to identify and ignore data values that are flagged as outliers. For example, a data value or parameter may be flagged as an outlier if its value is outside of an acceptable range of values for that specific type of parameter or data value.

In some implementations, the data acquisition module 102 also maintains a corrosion inhibitor dataset 116 that includes information about the availability of corrosion inhibitors. For example, the corrosion inhibitor dataset 116 can include a current list of the available corrosion inhibitors, a quantity of the available corrosion inhibitors, storage location of the available corrosion inhibitors, among other information. The data acquisition module 102 can update the corrosion inhibitor dataset 116 based on usage information of the corrosion inhibitors, order status of the corrosion inhibitors, shipment information of the corrosion inhibitors, or user provided data indicative of the corrosion inhibitors.

In some implementations, the machine learning module 104 uses the data stored in the database 108 to generate one or more machine learning models for corrosion rate prediction and/or corrosion inhibitor selection. The machine learning models serve as effective models for the selection of corrosion inhibitors and corrosion risk assessment. As described in more detail below, the corrosion treatment system 100 uses one or models to first conduct a corrosion risk assessment for a particular corrosive environment. Then, based on the corrosion risk assessment, the corrosion treatment system 100 uses the models to propose one or more corrosion inhibitors for the corrosive environment.

In some implementations, the machine learning module 104 uses the data stored in the database 108 to generate one or more machine learning models for corrosion rate prediction and/or corrosion inhibitor selection. In particular, a model generation module 118 of the machine learning module 104 uses the stored data to train the one or more machine learning models. In some examples, the model generation module 118 uses a plurality of input attributes for generating the machine learning models. The plurality of input attributes can include input parameters that control the corrosion rate and indicators of corrosion inhibitor performance of hydrocarbon flow in a particular pipe. The input parameters and/or the indicators can be determined, e.g., using laboratory tests. Within examples, the plurality of input attributes include chlorides concentration (conc) in parts per million (ppm), pH, hydrogen sulfide (H₂S) mole percent (mole %), carbon dioxide (CO₂) mole %, O₂ mole %, temperature (° F.), pressure in pounds per square gauge (psig), test duration in hours (h), flow speed in revolutions per minute (RPM), corrosion inhibitor (CI) name, and/or CI conc in ppm. The test duration is indicative of the time required in obtaining the laboratory test data for each test experiment to obtain the parameters.

In some implementations, the model generation module 118 uses one or more machine learning algorithms to generate the one or more models. Within examples, the one or more machine learning algorithms include hybrid machine-learning models of optimization techniques. In these techniques, Gradient Boosting and Random Forest classifiers are generated and evaluated using different evaluation metrics such as Coefficient of Determination, Root Mean Squared Error (RMSE), Mean Absolute Error (MAE), and Mean Absolute Percentage Error (MAPE). After generating the one or more models, the model generation module 118 stores the models as models 114 in the database 108.

In some implementations, the machine learning module 104 can use the models 114 for corrosion rate prediction and/or corrosion inhibitor selection. In some examples, the machine learning module 104 can automatically perform corrosion rate predictions. For instance, the machine learning module 104 can be configured to periodically perform corrosion rate predictions for specified hydrocarbon streams, structures, components, and/or equipment. In other examples, the machine learning module 104 can perform a corrosion rate prediction in response to a user input requesting the corrosion rate prediction to be performed for a particular component or stream.

In some implementations, the machine learning module 104 performs corrosion rate predictions based on real-time data that is indicative of attributes such as chlorides (ppm), pH, H₂S mole %, CO₂ mole %, O₂ mole %, T (° F.), P (psig), test duration (h), and/or RPM. The real-time data can be received from sensors and/or other measurement systems or apparatuses. Additionally or alternatively, the real-time data can be received from a user input. More specifically, the machine learning module 104 provides the real-time data as an input to the models 114. The models 114 use the real-time data to generate a predicted or expected corrosion rate for the given conditions.

In some implementations, after generating the predicted or expected corrosion rate for the given conditions, the machine learning module 104 determines whether a corrosion inhibitor is needed for that corrosion rate. In some examples, the machine learning module 104 determines that a corrosion inhibitor is needed if the corrosion rate is greater than a predetermined threshold. In some examples, if the corrosion rate is not greater than the predetermined threshold but is within a threshold percentage of the predetermined threshold, then the machine learning module 104 may flag the analyzed component for further evaluation sooner than initially scheduled. For instance, if the periodic evaluation for a component is on a monthly basis, then the machine learning module 104 may shift the periodic evaluation to biweekly in response to determining that the corrosion rate of the component is within a threshold percentage of the predetermined threshold.

In some implementations, in response to determine that a corrosion inhibitor is needed, the machine learning module 104 uses the models 114 to select a corrosion inhibitor from the corrosion inhibitor dataset 116. In some examples, the machine learning module 104 provides the real-time data as input to the models 114. The models 114 generate, based on the input data, an output that includes one or more recommended corrosion inhibitors. The output may additionally include a concentration and/or an application method. Additionally and/or alternatively, the machine learning module 104 can generate instructions for the triggered actions 110. The triggered actions include displaying on a display device an indication of the recommended corrosion inhibitors, sounding an audible alarm indicating that a corrosion rate has exceeded the predetermined threshold, and/or causing the recommended corrosion inhibitor to be injected into an appropriate hydrocarbon stream.

To illustrate the operation of the corrosion treatment system 100, consider the following example. In this example, the example corrosion treatment system 100 receives real-time input data from a hydrocarbon drilling or processing system. The real-time input can include parameters such as, chlorides, pH, H₂S mole %, CO₂ mole %, O₂ mole %, T (° F.), P (psig), test duration (h), and/or RPM. Table 1 includes some example values for the real-time input data.

TABLE 1
Real-time Data

| Chlorides | | H₂S | CO₂ | O₂ | T | P | Test Duration | |
|---|---|---|---|---|---|---|---|---|
| (ppm) | pH | (mole %) | (mole %) | (mole %) | (° F.) | (psig) | (h) | RPM |
| 17260 | 6.8 | 0 | 1.4 | 0 | 140 | 1400 | 72 | 500 |

After receiving the real-time input data, the corrosion treatment system 100 provides the data to the machine learning module 104, which determines a corrosion rate for the given conditions. In this example, the machine learning module 104 determines that the corrosion rate is greater than a predetermined threshold. Then, the machine learning module 104 responsively determines to select a corrosion inhibitor to mitigate or inhibit the corrosion rate. The machine learning module 104 then selects a corrosion inhibitor, e.g., from the corrosion inhibitor dataset 116. In this example, the corrosion inhibitor dataset 116 includes two types of corrosion inhibitors (CI-A-1, CI-B-1) with two different possible concentrations, as shown in Table 2.

TABLE 2
An example of corrosion inhibitor data
from a corrosion inhibitor database

| CI Name | CI Conc ppm |
|---|---|
| CI-A-1 | 10 |
| CI-A-1 | 20 |
| CI-B-1 | 10 |
| CI-B-1 | 20 |

The machine learning module 104 uses the real-time data in Table 1 and the corrosion inhibitor dataset in Table 2 to generate five possible outcomes, as shown in Table 3. A first possible outcome is not applying a corrosion inhibitor, which is designated as the baseline. Since there is no corrosion inhibitor, in Table 3 the “CI Name” is represented as “Blank” with a zero concentration value for “CI Conc.” The remaining four cases involve using corrosion inhibitors with their corresponding concentrations (the data from Table 2).

TABLE 3
Final Input Cases to the ML Model

| | | | | | | | Test | | | CI |
|---|---|---|---|---|---|---|---|---|---|---|
| Chlorides | | H₂S | CO₂ | O₂ | T | P | Duration | | CI | Conc |
| ppm | pH | mole % | mole % | mole % | ° F. | psig | h | RPM | Name | ppm |
| 17260 | 6.8 | 0 | 1.4 | 0 | 140 | 1400 | 72 | 500 | Blank | 0 |
| 17260 | 6.8 | 0 | 1.4 | 0 | 140 | 1400 | 72 | 500 | CI-A-1 | 10 |
| 17260 | 6.8 | 0 | 1.4 | 0 | 140 | 1400 | 72 | 500 | CI-A-1 | 20 |
| 17260 | 6.8 | 0 | 1.4 | 0 | 140 | 1400 | 72 | 500 | CI-B-1 | 10 |
| 17260 | 6.8 | 0 | 1.4 | 0 | 140 | 1400 | 72 | 500 | CI-B-1 | 20 |

The corrosion treatment system 100 will provide the data in Table 3 as input to the models 114. In this example, the models 114 predict five corrosion rates for the input cases. The first value (obtained for the first row in Table 3) is for the baseline by which the corrosion treatment system 100 can determine whether to apply the corrosion inhibitor. If the predicted corrosion rate is larger than a predetermined threshold (which is indicative of corrosion risk), the corrosion treatment system 100 will apply corrosion inhibitors. In particular, the corrosion treatment system 100 predicts the corrosion rate for each case and compares it with the baseline. In some examples, the corrosion treatment system 100 recommends the corrosion inhibitor that achieves the lowest predicted corrosion rate. The output includes a corrosion inhibitor name, the corrosion inhibitor concentration, and an estimated corrosion rate when applying the selected corrosion inhibitor.

The corrosion treatment system 100 provides corrosion-risk assessment and selects an efficient inhibitor suitable for the expected service environment. This will overcome the significant cost and time-consuming activities in assessing the corrosion risks and selecting the best corrosion inhibitor for a given environment. The corrosion treatment system 100 reduces the cost of testing new corrosion inhibitors for field deployment and is capable of acquiring new corrosion data to enhance its accuracy.

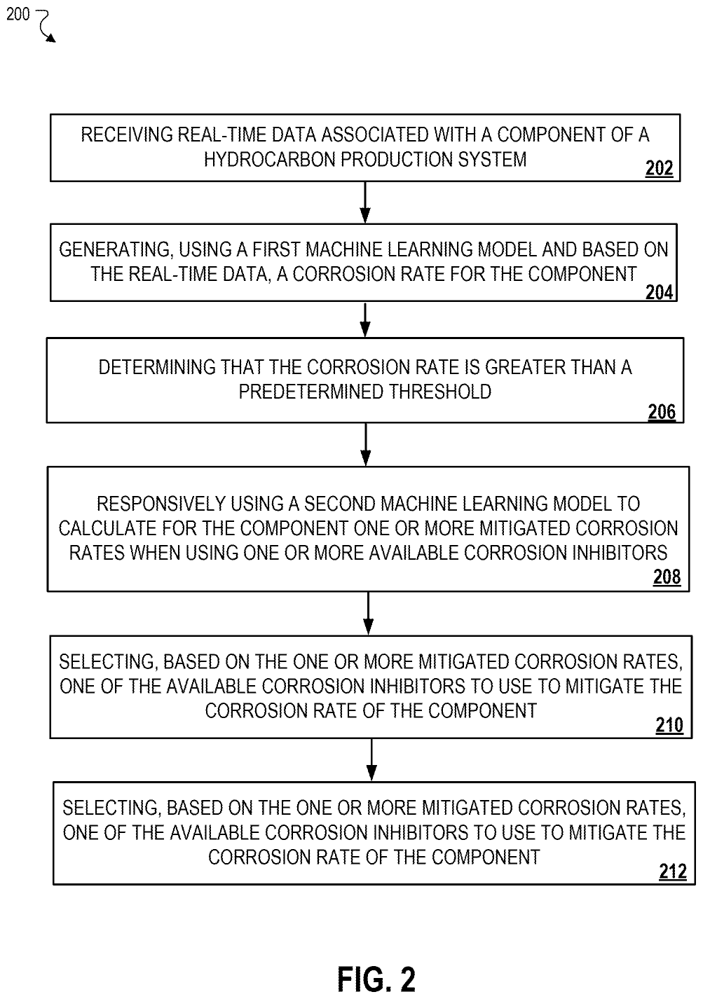

FIG. 2 illustrates a flowchart of an example method 200, according to some implementations. For clarity of presentation, the description that follows generally describes method 500 in the context of the other figures in this description. For example, method 200 can be performed by corrosion treatment system 100 of FIG. 1. It will be understood that method 200 can be performed, for example, by any suitable system, environment, software, hardware, or a combination of systems, environments, software, and hardware, as appropriate. In some implementations, various steps of method 200 can be run in parallel, in combination, in loops, or in any order.

At step 202, the method 200 involves receiving real-time data associated with a component of a hydrocarbon production system.

At step 204, the method 200 involves generating, using a first machine learning model and based on the real-time data, a corrosion rate for the component.

At step 206, the method 200 involves determining that the corrosion rate is greater than a predetermined threshold.

At step 208, the method 200 involves responsively using a second machine learning model to calculate for the component one or more mitigated corrosion rates when using one or more available corrosion inhibitors.

At step 210, the method 200 involves selecting, based on the one or more mitigated corrosion rates, one of the available corrosion inhibitors to use to mitigate the corrosion rate of the component.

At step 212, the method 200 involves responsively performing one or more mitigating actions to mitigate the corrosion rate of the component.

In some implementations, the first and second machine learning models are trained using at least one of: historical field data, simulation data, or lab data.

In some implementations, the first and second machine learning models are trained using at least one of gradient boosting classifiers or random forest classifiers.

In some implementations, the at least one of the gradient boosting classifiers or the random forest classifiers are evaluated using at least one of coefficient of determination, root mean squared error (RMSE), mean absolute error (MAE), or mean absolute percentage error (MAPE).

In some implementations, the real-time data includes at least one of: a chlorides concentration in parts per million (ppm), pH, hydrogen sulfide (H₂S) mole percent (mole %), carbon dioxide (CO₂) mole %, O₂ mole %, temperature (° F.), pressure in pounds per square gauge (psig), test duration in hours (h), or flow speed in revolutions per minute (RPM).

In some implementations, responsively performing one or more mitigating actions to mitigate the corrosion rate of the component involves at least one of displaying on a display device an indication of the selected corrosion inhibitor, sounding an audible alarm indicating that the corrosion rate is greater than the predetermined threshold, or causing the selected corrosion inhibitor to be injected into an appropriate hydrocarbon stream that comes into contact with the component.

In some implementations, selecting, based on the one or more mitigated corrosion rates, one of the available corrosion inhibitors to use to mitigate the corrosion rate of the component further involves selecting a concentration of the selected available corrosion inhibitor.

In some implementations, the selected available corrosion inhibitor has the lowest one of the one or more mitigated corrosion rates.

FIG. 3 is a block diagram of an example computer system 300 that can be used to provide computational functionalities associated with described algorithms, methods, functions, processes, flows, and procedures, according to some implementations of the present disclosure. In some implementations, the corrosion treatment system 100 can be the computer system 300, include the computer system 300, or the corrosion treatment system 100 can communicate with the computer system 300.

The illustrated computer 302 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 302 can include input devices such as keypads, keyboards, and touch screens that can accept user information. Also, the computer 302 can include output devices that can convey information associated with the operation of the computer 302. The information can include digital data, visual data, audio information, or a combination of information. The information can be presented in a graphical user interface (UI) (or GUI). In some implementations, the inputs and outputs include display ports (such as DVI-I+2× display ports), USB 3.0, GbE ports, isolated DI/O, SATA-III (6.0 Gb/s) ports, mPCIe slots, a combination of these, or other ports. In instances of an edge gateway, the computer 302 can include a Smart Embedded Management Agent (SEMA), such as a built-in ADLINK SEMA 2.2, and a video sync technology, such as Quick Sync Video technology supported by ADLINK MSDK+. In some examples, the computer 302 can include the MXE-5400 Series processor-based fanless embedded computer by ADLINK, though the computer 302 can take other forms or include other components.

The computer 302 can serve in a role as a client, a network component, a server, a database, a persistency, or components of a computer system for performing the subject matter described in the present disclosure. The illustrated computer 302 is communicably coupled with a network 330. In some implementations, one or more components of the computer 302 can be configured to operate within different environments, including cloud-computing-based environments, local environments, global environments, and combinations of environments.

At a high level, the computer 302 is an electronic computing device operable to receive, transmit, process, store, and manage data and information associated with the described subject matter. According to some implementations, the computer 302 can also include, or be communicably coupled with, an application server, an email server, a web server, a caching server, a streaming data server, or a combination of servers.

The computer 302 can receive requests over network 330 from a client application (for example, executing on another computer 302). The computer 302 can respond to the received requests by processing the received requests using software applications. Requests can also be sent to the computer 302 from internal users (for example, from a command console), external (or third) parties, automated applications, entities, individuals, systems, and computers.

Each of the components of the computer 302 can communicate using a system bus 303. In some implementations, any or all of the components of the computer 302, including hardware or software components, can interface with each other or the interface 304 (or a combination of both), over the system bus. Interfaces can use an application programming interface (API) 312, a service layer 313, or a combination of the API 312 and service layer 313. The API 312 can include specifications for routines, data structures, and object classes. The API 312 can be either computer-language independent or dependent. The API 312 can refer to a complete interface, a single function, or a set of APIs 312.

The service layer 313 can provide software services to the computer 302 and other components (whether illustrated or not) that are communicably coupled to the computer 302. The functionality of the computer 302 can be accessible for all service consumers using this service layer 313. Software services, such as those provided by the service layer 313, can provide reusable, defined functionalities through a defined interface. For example, the interface can be software written in JAVA, C++, or a language providing data in extensible markup language (XML) format. While illustrated as an integrated component of the computer 302, in alternative implementations, the API 312 or the service layer 313 can be stand-alone components in relation to other components of the computer 302 and other components communicably coupled to the computer 302. Moreover, any or all parts of the API 312 or the service layer 313 can be implemented as child or sub-modules of another software module, enterprise application, or hardware module without departing from the scope of the present disclosure.

The computer 302 can include an interface 304. Although illustrated as a single interface 304 in FIG. 3, two or more interfaces 304 can be used according to particular needs, desires, or particular implementations of the computer 302 and the described functionality. The interface 304 can be used by the computer 302 for communicating with other systems that are connected to the network 330 (whether illustrated or not) in a distributed environment. Generally, the interface 304 can include, or be implemented using, logic encoded in software or hardware (or a combination of software and hardware) operable to communicate with the network 330. More specifically, the interface 304 can include software supporting one or more communication protocols associated with communications. As such, the network 330 or the interface's hardware can be operable to communicate physical signals within and outside of the illustrated computer 302.

The computer 302 includes a processor 305. Although illustrated as a single processor 305 in FIG. 3, two or more processors 305 can be used according to particular needs, desires, or particular implementations of the computer 302 and the described functionality. Generally, the processor 305 can execute instructions and manipulate data to perform the operations of the computer 302, including operations using algorithms, methods, functions, processes, flows, and procedures as described in the present disclosure.

The computer 302 can also include a database 306 that can hold data for the computer 302 and other components connected to the network 330 (whether illustrated or not). For example, database 306 can be an in-memory, conventional, or a database storing data consistent with the present disclosure. In some implementations, the database 306 can be a combination of two or more different database types (for example, hybrid in-memory and conventional databases) according to particular needs, desires, or particular implementations of the computer 302 and the described functionality. Although illustrated as a single database 306 in FIG. 3, two or more databases (of the same, different, or combination of types) can be used according to particular needs, desires, or particular implementations of the computer 302 and the described functionality. While database 306 is illustrated as an internal component of the computer 302, in alternative implementations, database 306 can be external to the computer 302.

The computer 302 also includes a memory 307 that can hold data for the computer 302 or a combination of components connected to the network 330 (whether illustrated or not). Memory 307 can store any data consistent with the present disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307 in FIG. 3, two or more memories 307 (of the same, different, or combination of types) can be used according to particular needs, desires, or particular implementations of the computer 302 and the described functionality. While memory 307 is illustrated as an internal component of the computer 302, in alternative implementations, memory 307 can be external to the computer 302.

An application 308 can be an algorithmic software engine providing functionality according to particular needs, desires, or particular implementations of the computer 302 and the described functionality. For example, an application 308 can serve as one or more components, modules, or applications 308. Multiple applications 308 can be implemented on the computer 302. Each application 308 can be internal or external to the computer 302.

The computer 302 can also include a power supply 314. The power supply 314 can include a rechargeable or non-rechargeable battery that can be configured to be either user- or non-user-replaceable. In some implementations, the power supply 314 can include power-conversion and management circuits, including recharging, standby, and power management functionalities. In some implementations, the power-supply 314 can include a power plug to allow the computer 302 to be plugged into a wall socket or a power source to, for example, power the computer 302 or recharge a rechargeable battery.

There can be any number of computers 302 associated with, or external to, a computer system including computer 302, with each computer 302 communicating over network 330. Further, the terms “client,” “user,” and other appropriate terminology can be used interchangeably without departing from the scope of the present disclosure. Moreover, the present disclosure contemplates that many users can use one computer 302 and one user can use multiple computers 302.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random-access memory (RAM), read only memory (ROM), phase change memory (PRAM), static random-access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A method comprising:
receiving real-time data associated with a component of a hydrocarbon production system;
generating, using a first machine learning model and based on the real-time data, a corrosion rate for the component;
determining that the corrosion rate is greater than a predetermined threshold;
responsively using a second machine learning model to calculate for the component one or more mitigated corrosion rates when using one or more available corrosion inhibitors;
selecting, based on the one or more mitigated corrosion rates, one of the available corrosion inhibitors to use to mitigate the corrosion rate of the component; and
responsively performing one or more mitigating actions to mitigate the corrosion rate of the component.

2. The method of claim 1, wherein the first and second machine learning models are trained using at least one of: historical field data, simulation data, or lab data.

3. The method of claim 1, wherein the first and second machine learning models are trained using at least one of gradient boosting classifiers or random forest classifiers.

4. The method of claim 3, wherein the at least one of the gradient boosting classifiers or the random forest classifiers are evaluated using at least one of coefficient of determination, root mean squared error (RMSE), mean absolute error (MAE), or mean absolute percentage error (MAPE).

5. The method of claim 1, wherein the real-time data includes at least one of: a chlorides concentration in parts per million (ppm), pH, hydrogen sulfide (H₂S) mole percent (mole %), carbon dioxide (CO₂) mole %, O₂ mole %, temperature (° F.), pressure in pounds per square gauge (psig), test duration in hours (h), or flow speed in revolutions per minute (RPM).

6. The method of claim 1, wherein responsively performing one or more mitigating actions to mitigate the corrosion rate of the component comprises at least one of displaying on a display device an indication of the selected corrosion inhibitor, sounding an audible alarm indicating that the corrosion rate is greater than the predetermined threshold, or causing the selected corrosion inhibitor to be injected into an appropriate hydrocarbon stream that comes into contact with the component.

7. The method of claim 1, wherein selecting, based on the one or more mitigated corrosion rates, one of the available corrosion inhibitors to use to mitigate the corrosion rate of the component further comprises:
selecting a concentration of the selected available corrosion inhibitor.

8. The method of claim 1, wherein the selected available corrosion inhibitor has the lowest one of the one or more mitigated corrosion rates.

9. A system comprising:
one or more processors configured to perform operations comprising:
receiving real-time data associated with a component of a hydrocarbon production system;
generating, using a first machine learning model and based on the real-time data, a corrosion rate for the component;
determining that the corrosion rate is greater than a predetermined threshold;
responsively using a second machine learning model to calculate for the component one or more mitigated corrosion rates when using one or more available corrosion inhibitors;
selecting, based on the one or more mitigated corrosion rates, one of the available corrosion inhibitors to use to mitigate the corrosion rate of the component; and
responsively performing one or more mitigating actions to mitigate the corrosion rate of the component.

10. The system of claim 9, wherein the first and second machine learning models are trained using at least one of: historical field data, simulation data, or lab data.

11. The system of claim 9, wherein the first and second machine learning models are trained using at least one of gradient boosting classifiers or random forest classifiers.

12. The system of claim 1_, wherein the at least one of the gradient boosting classifiers or the random forest classifiers are evaluated using at least one of coefficient of determination, root mean squared error (RMSE), mean absolute error (MAE), or mean absolute percentage error (MAPE).

13. The system of claim 9, wherein the real-time data includes at least one of: a chlorides concentration in parts per million (ppm), pH, hydrogen sulfide (H₂S) mole percent (mole %), carbon dioxide (CO₂) mole %, O₂ mole %, temperature (° F.), pressure in pounds per square gauge (psig), test duration in hours (h), or flow speed in revolutions per minute (RPM).

14. The system of claim 9, wherein responsively performing one or more mitigating actions to mitigate the corrosion rate of the component comprises at least one of displaying on a display device an indication of the selected corrosion inhibitor, sounding an audible alarm indicating that the corrosion rate is greater than the predetermined threshold, or causing the selected corrosion inhibitor to be injected into an appropriate hydrocarbon stream that comes into contact with the component.

15. The system of claim 9, wherein selecting, based on the one or more mitigated corrosion rates, one of the available corrosion inhibitors to use to mitigate the corrosion rate of the component further comprises:
selecting a concentration of the selected available corrosion inhibitor.

16. The system of claim 9, wherein the selected available corrosion inhibitor has the lowest one of the one or more mitigated corrosion rates.

17. A non-transitory computer storage medium encoded with instructions that, when executed by one or more computers, cause the one or more computers to perform operations comprising:
receiving real-time data associated with a component of a hydrocarbon production system;
generating, using a first machine learning model and based on the real-time data, a corrosion rate for the component;
determining that the corrosion rate is greater than a predetermined threshold;
responsively using a second machine learning model to calculate for the component one or more mitigated corrosion rates when using one or more available corrosion inhibitors;
selecting, based on the one or more mitigated corrosion rates, one of the available corrosion inhibitors to use to mitigate the corrosion rate of the component; and
responsively performing one or more mitigating actions to mitigate the corrosion rate of the component.

18. The non-transitory computer storage medium of claim 17, wherein the first and second machine learning models are trained using at least one of: historical field data, simulation data, or lab data.

19. The non-transitory computer storage medium of claim 17, wherein the first and second machine learning models are trained using at least one of gradient boosting classifiers or random forest classifiers.

20. The non-transitory computer storage medium of claim 19, wherein the at least one of the gradient boosting classifiers or the random forest classifiers are evaluated using at least one of coefficient of determination, root mean squared error (RMSE), mean absolute error (MAE), or mean absolute percentage error (MAPE).
